(19) United States
(12) Patent Application Publication
(10) Pub. No.: US 2023/0240917 A1
(43) Pub. Date: Aug. 3, 2023

(54) BRACKETS FOR PORTABLE EQUIPMENT

(71) Applicant: TECHNOLOGIES CGC INC., Quebec (CA)

(72) Inventor: Carl BOUCHARD, Quebec (CA)

(21) Appl. No.: 17/926,276

(22) PCT Filed: May 20, 2021
(86) PCT No.: PCT/CA2021/050685

§ 371 Date: Nov. 18, 2022

Related U.S. Application Data
(60) Provisional application No. 63/027,548, filed on May 20, 2020.

(51) Int. Cl. A61G 1/04; F16M 11/08; F16M 13/02

(52) U.S. Cl. CPC A61G 1/04; F16M 11/08; F16M 13/02

(57) ABSTRACT

A bracket for supporting portable equipment, the bracket comprising: a body which is plate-like and having an upper surface for supporting the portable equipment, the body comprising: a central portion, a first wing portion extending from a first side of the central portion, and a second wing portion extending from a second side of the central portion; at least one leg extending downwardly from a lower surface of the body to space the supported portable equipment from a surface in use; wherein a planar surface of the first wing portion is off-set by a first angle with respect to a planar surface of the central portion, and a planar surface of the second wing portion is off-set by a second angle with respect to the planar surface of the central portion.

### TECHNICAL FIELD

The present technology relates to brackets for supporting portable equipment, and more specifically although not exclusively to brackets for supporting portable medical equipment.

### BACKGROUND

Support for portable equipment, such as medical equipment, can be provided using brackets. Such brackets may be configured to be attachable to the portable equipment, and may include a handle for ease of carrying the portable equipment. In some cases, an attachment system may be provided for attaching the portable equipment and the bracket to a transportation system such as a stretcher, a wheelchair or a portable bed.

These types of brackets tend to have a plate-like structure and are made of metal in order to provide enough strength and rigidity to support heavy portable equipment. The portable nature of the equipment also requires that the bracket weight is kept to a minimum without compromising the strength of the bracket. However, material failure of these brackets is not uncommon, especially following impact to the bracket such as when dropped and other high load impact occasions.

Therefore, there is a need for brackets suitable for supporting portable equipment such as portable medical equipment and which overcome or reduce at least some of the above-described problems.

### SUMMARY

Embodiments of the present technology have been developed based on inventors' appreciation of at least one shortcoming associated with the prior art approaches to brackets for supporting portable equipment. Fractures and deformations of the brackets have been observed, especially after being dropped.

Accordingly, from a first aspect of the present disclosure, there is provided a bracket for supporting portable equipment, the bracket comprising: a body which is plate-like and having an upper surface for supporting the portable equipment, the body comprising: a central portion, a first wing portion extending from a first side of the central portion, and a second wing portion extending from a second side of the central portion; at least one leg extending downwardly from a lower surface of the body to space the supported portable equipment from a surface in use; wherein a planar surface of the first wing portion is off-set by a first angle with respect to a planar surface of the central portion, and a planar surface of the second wing portion is off-set by a second angle with respect to the planar surface of the central portion.

From another aspect, there is provided a bracket for supporting portable equipment, the bracket comprising: a body which is plate-like and has an upper surface which is arranged to support the portable equipment, and a lower surface having at least one leg extending downwardly therefrom to space the supported portable equipment from a surface in use; wherein the bracket is one-piece and made of a material that can withstand a static vertical load of more than 200 lb without fracture. The body may comprise a central portion, a first wing portion extending from a first side of the central portion, and a second wing portion extending from a second side of the central portion; wherein a planar surface of the first wing portion is off-set by a first angle with respect to a planar surface of the central portion, and a planar surface of the second wing portion is off-set by a second angle with respect to the planar surface of the central portion.

In any of the above aspects and in certain embodiments, the planar surface of the first wing portion, the planar surface of the second wing portion, and the planar surface of the central portion define the upper surface of the body, and wherein the first angle is about 3 degrees to about 10 degrees, about 3 degrees to about 9 degrees, about 3 degrees to about 8 degrees, about 4 degrees to about 10 degrees about 3 degrees, about 4 degrees to about 9 degrees, about 4 degrees to about 8 degrees, about 4 degrees to about 7 degrees, about 4 degrees to about 6 degrees, about 7 degrees, about 6 degrees or about 5 degrees.

In any of the above aspects and in certain embodiments, the second angle is about 3 degrees to about 10 degrees, about 3 degrees to about 9 degrees, about 3 degrees to about 8 degrees, about 4 degrees to about 10 degrees about 3 degrees, about 4 degrees to about 9 degrees, about 4 degrees to about 8 degrees, about 4 degrees to about 7 degrees, about 4 degrees to about 6 degrees, about 7 degrees, about 6 degrees or about 5 degrees.

In any of the above aspects and in certain embodiments, the at least one leg is integrally formed with the body. In certain embodiments, the at least one leg comprises four legs which are spaced from one another.

In any of the above aspects and in certain embodiments, when the at least one leg is resting on a surface, the bracket is configured such that a distance of the central portion from the surface is greater than a distance of the first wing portion or a first side edge of the first wing portion, and a distance of the second wing portion or a second side edge of the second wing portion, respectively, from the surface.

In any of the above aspects and in certain embodiments, the first wing portion, the central portion and the second wing portion present a substantially concave profile of the body in cross-section.

In any of the above aspects and in certain embodiments, a width of the central portion is more than a width of each of the first wing portion and the second wing portion.

In any of the above aspects and in certain embodiments, the width of the central portion is about twice the width of each of the first wing portion and the second wing portion.

In any of the above aspects and in certain embodiments, the body is made of a material having a higher impact toughness than aluminium.

In any of the above aspects and in certain embodiments, the body is made of a material which can withstand a static load of 200 lb.

In any of the above aspects and in certain embodiments, the body is made of a polymer comprising one or more of a thermoplastic, an elastomer, and a thermoset polymer. In certain embodiments, the body is made of acrylonitrile butadiene styrene (ABS). In certain other embodiments, the body is made of a metal and has a polymer coating. In certain embodiments, the body is made of a material which is more flexible than aluminium.

In any of the above aspects and in certain embodiments, the bracket further comprises a handle connected to the body.

In any of the above aspects and in certain embodiments, the handle is integral with the body and formed therein. In other words, the handle and the body are a single piece.

In any of the above aspects and in certain embodiments, the handle is formed in the central portion of the body.

In any of the above aspects and in certain embodiments, the bracket is one-piece. The bracket can be formed by molding, casting, or additive manufacturing.

In any of the above aspects and in certain embodiments, the first wing portion and the second wing portion are each a single piece with no openings.

In any of the above aspects and in certain embodiments, each of the first wing portion and the second wing portion are substantially trapezoidal in shape comprising three exposed sides and a fourth side which is integrally formed with the central portion. The first wing portion has a first side edge with is substantially parallel to a second side edge of the second wing portion. At least one of the three exposed sides may be substantially straight.

In any of the above aspects and in certain embodiments, the planar surfaces of each of the first wing portion and the second wing portion at the upper surface of the body are uninterrupted.

In any of the above aspects and in certain embodiments, wherein the at least one leg comprises four legs, first and second legs of the four legs extending from the first wing portion and third and fourth legs of the four legs extending from the second wing portion.

In any of the above aspects and in certain embodiments, a portion of the upper surface 16 is configured to contact the portable equipment 12 for supporting the portable equipment.

In any of the above aspects and in certain embodiments, wherein the planar surface of the central portion at the upper surface of the body comprises a recessed portion for receiving a plate for connecting the mobile equipment to the bracket, and optionally further comprising the plate sized and shaped to be received in the recessed portion. The plate may be made of aluminium. In use, the bracket is sandwiched between the plate and the coupling device. The mobile equipment can be attached to the plate before attaching the plate to the bracket.

In any of the above aspects and in certain embodiments, wherein the central portion comprises a central opening formed therein.

In any of the above aspects and in certain embodiments, wherein the central opening is defined within the recessed portion. The opening may be circular.

In any of the above aspects and in certain embodiments, the bracket further comprises peripheral openings formed in the body around the central opening.

In any of the above aspects and in certain embodiments, wherein a total surface area of the upper surface of the body, comprising a sum of the upper planar surface of the first wing portion, the upper planar surface of the second wing portion and the upper planar surface of central portion, is more than about 35 in² and less than about 100 in². In certain embodiments, the total surface area is about 40 in², about 45 in², about 50 in², about 55 in², about 60 in², about 65 in², or about 70 in².

In any of the above aspects and in certain embodiments, the bracket further comprises a release member of a coupling device, the coupling device arranged to releasably attach the bracket to a support surface in use, the release member comprising a plate-like body with a first side, the first side defining a planar contact face, and a second side having a collar extending therefrom, the collar positioned inwardly of a perimeter of the release member to define a flange portion.

In any of the above aspects and in certain embodiments, the bracket further comprises a base member of the coupling device, the base member and the release member being releasably connectable together in a coupled position, the base member being connectable to the support surface and having: a front face including a planar contact portion for contacting the contact face of the release member; a shoulder extending around a portion of a periphery of the planar portion to define a pocket for receiving the release member, the shoulder engageable with a portion of the flange of the release member when the release member is positioned on the base member; an open access end through which the release member can be slidingly inserted and removed from the pocket; a stop member positioned in a recess within the planar contact portion and moveable by a resilient lock mechanism and an actuator between a lock position in which at least a portion of the stop member extends from the recess and abuts an edge of an opening defined in the release member contact face in the coupled position, and a release position in which the stop member is retracted into the recess; the actuator having a neutral position and a deployed position, wherein when the actuator is in the neutral position, the stop member is resiliently biased towards the lock position.

In any of the above aspects and in certain embodiments, the base member comprises a plurality of spring loaded ball bearings partially extending from recesses formed in the front face of the base member and engageable with corresponding recesses defined in the planar contact face of the release member.

In any of the above aspects and in certain embodiments, the planar contact face of the release member has an anti-friction layer.

In any of the above aspects and in certain embodiments, further comprising a damping member attachable to a back face of the base member and arranged to be positioned between the base portion and the surface in use, the damping member being arranged to absorb vibration and/or shock.

In any of the above aspects and in certain embodiments, further comprising a top plate attachable to the collar of the release member and attachable to the mobile equipment.

In any of the above aspects and in certain embodiments, wherein the perimeter of the plate-like body of the release member is circular in shape, the stop member of the base member is positioned substantially centrally of the planar contact portion, and the opening of the release member is positioned substantially centrally of the plate-like body, such that the release member can be rotated within the pocket when the stop member is in the lock position.

In any of the above aspects and in certain embodiments, wherein the perimeter of the plate-like body of the release member has an eccentric shape such that the release member is not rotatable in the pocket of the base member.

In any of the above aspects and in certain embodiments, the bracket is flexible.

In certain embodiments, the bracket can absorb energy on impact (e.g. shock energy) thereby avoiding fracture and other damage. In certain embodiments, when the bracket is dropped and impacts a surface by its legs, the body can flex to absorb the shock. In certain embodiments, any mobile equipment connected to the bracket is also thus protected.

These and other aspects and features of non-limiting embodiments will now become apparent to those skilled in the art upon review of the following description of specific non-limiting embodiments in conjunction with the accompanying drawings.

### DETAILED DESCRIPTION OF THE DRAWINGS

The non-limiting embodiments will be more fully appreciated by reference to the accompanying drawings, in which:

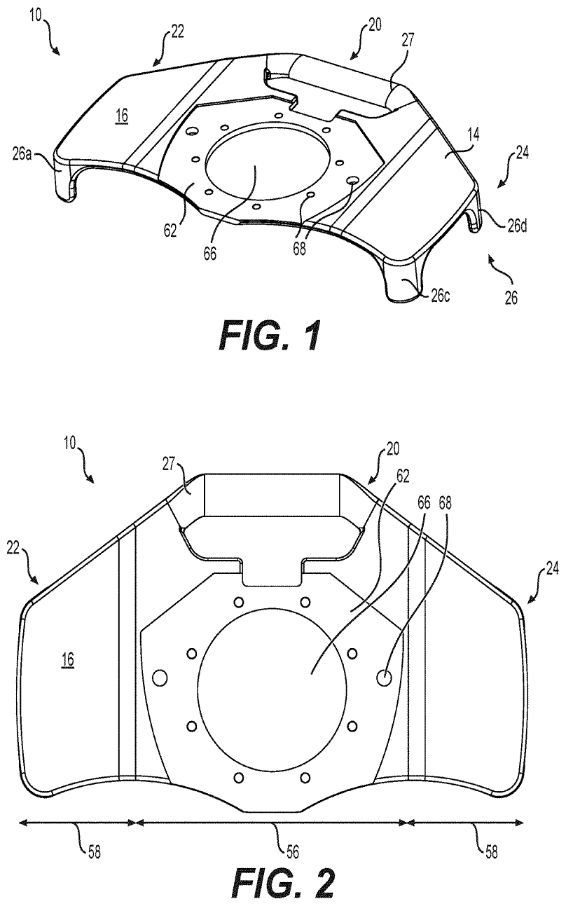

FIG. 1 is a perspective view from a front end of a bracket, according to certain embodiments of the present technology.

FIG. 2 is a top plan view of the bracket of FIG. 1, according to certain embodiments of the present technology.

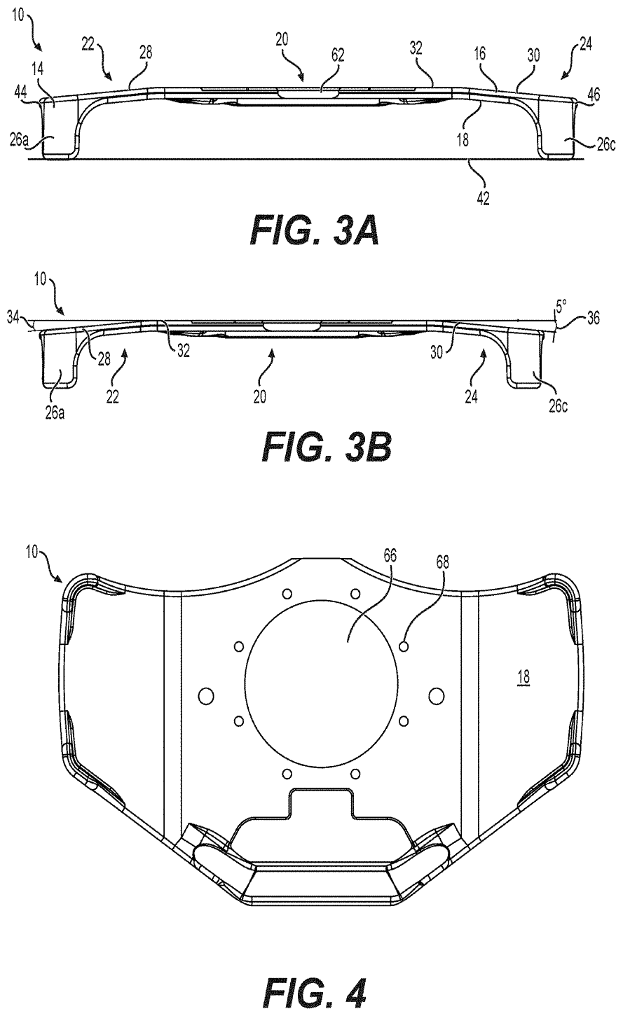

FIG. 3A is a front end view of the bracket of FIG. 1, according to certain embodiments of the present technology.

FIG. 3B is the front end view of the bracket of FIG. 3A showing a change in angle of an upper surface of the bracket, according to certain embodiments of the present technology.

FIG. 4 is a bottom plan view of the bracket of FIG. 1, according to certain embodiments of the present technology.

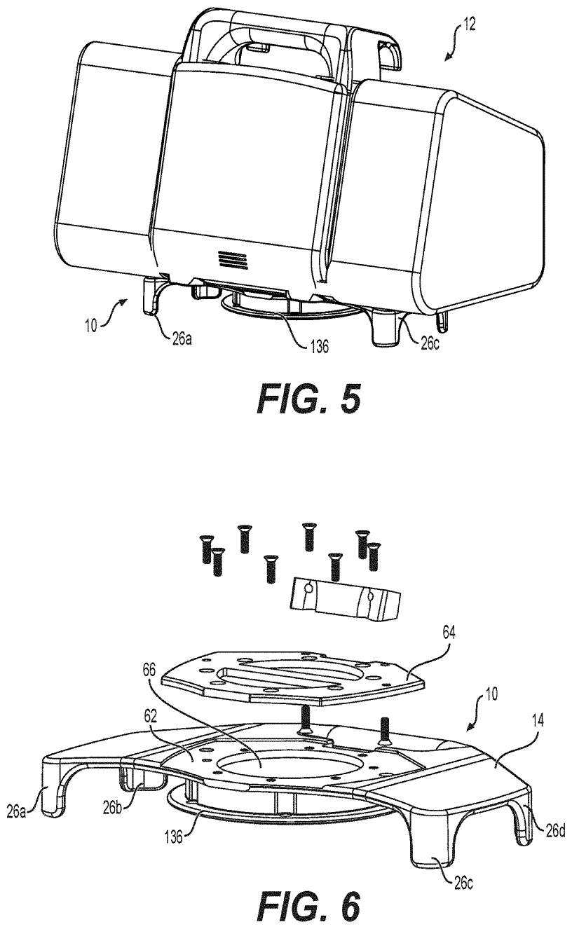

FIG. 5 is the bracket of FIG. 1 with a portable equipment and a release member of a coupling device attached thereto, according to certain embodiments of the present technology.

FIG. 6 is an exploded view of the bracket, the portable equipment and the release member of FIG. 5, according to certain embodiments of the present technology.

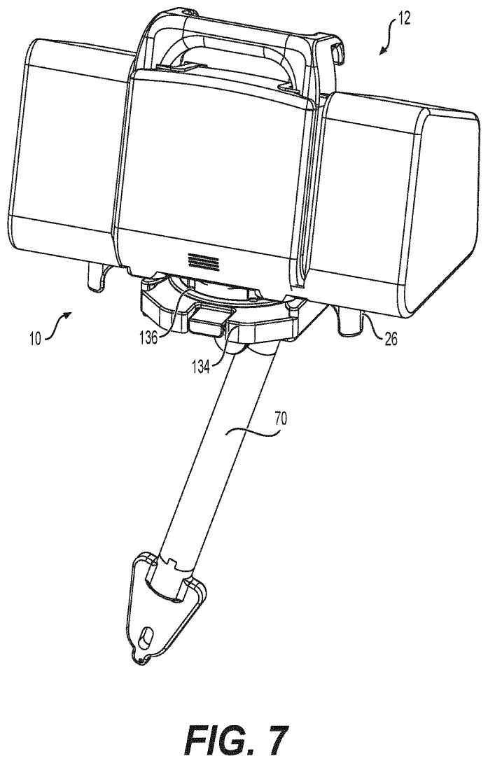

FIG. 7 is an assembly comprising the bracket of FIG. 5, a portable equipment attached to to the bracket, release and base members of a coupling device, and a support arm, according to certain embodiments of the present technology.

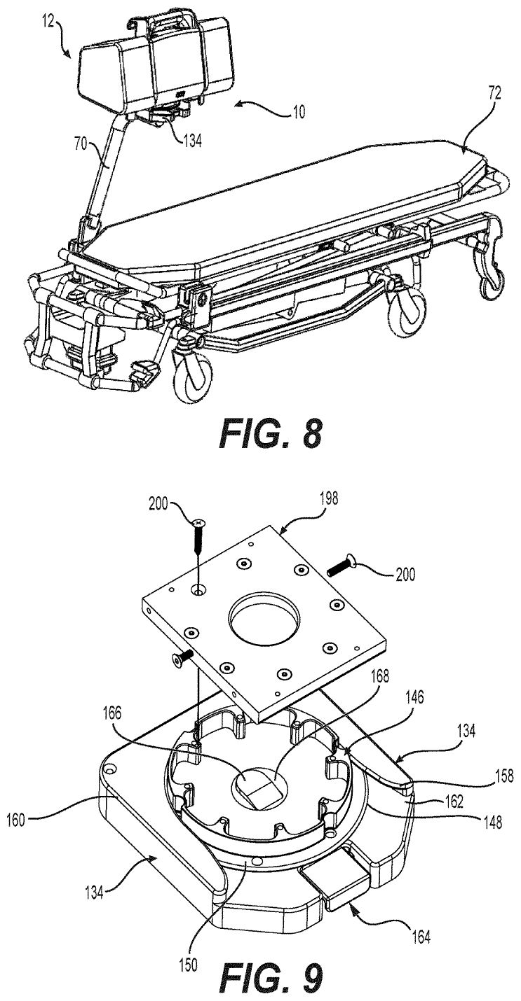

FIG. 8 is the assembly of FIG. 7 attached to a stretcher, according to certain embodiments of the present technology.

FIG. 9 is a coupling device comprising a base member, a release member, and a top plate, according to certain embodiments of the present disclosure.

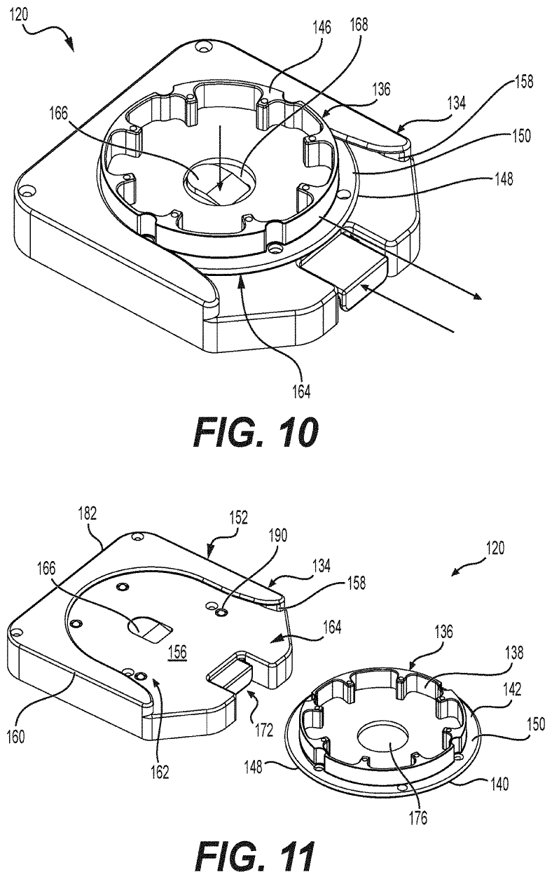

FIG. 10 is the coupling device of FIG. 9, with the top plate removed for clarity, when in the coupled and lock position, according to certain embodiments of the present disclosure.

FIG. 11 is the coupling device of FIG. 9, when in the uncoupled and unlock position, according to certain embodiments of the present disclosure.

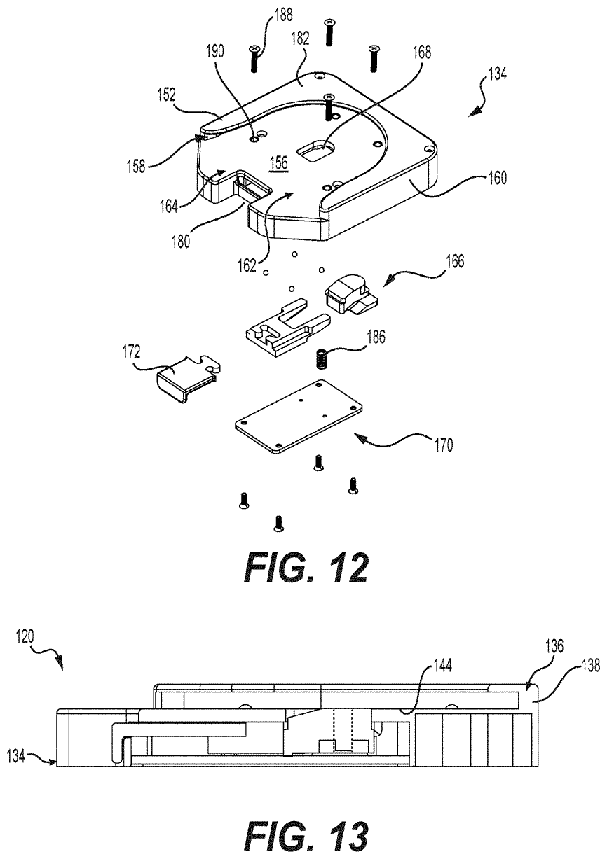

FIG. 12 is an exploded view of the base member of FIG. 9, according to certain embodiments of the present disclosure.

FIG. 13 is a cross-sectional view of the coupling device of FIG. 9, according to certain embodiments of the present disclosure.

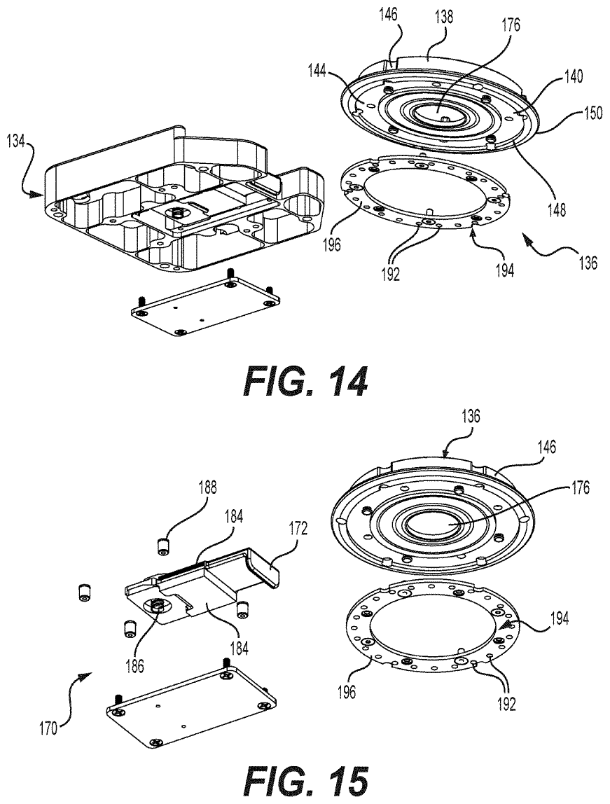

FIG. 14 is an exploded view of the base member and the release member of FIG. 9, according to certain embodiments of the present disclosure.

FIG. 15 is an exploded view of the release member of FIG. 9 and a lock mechanism, according to certain embodiments of the present disclosure.

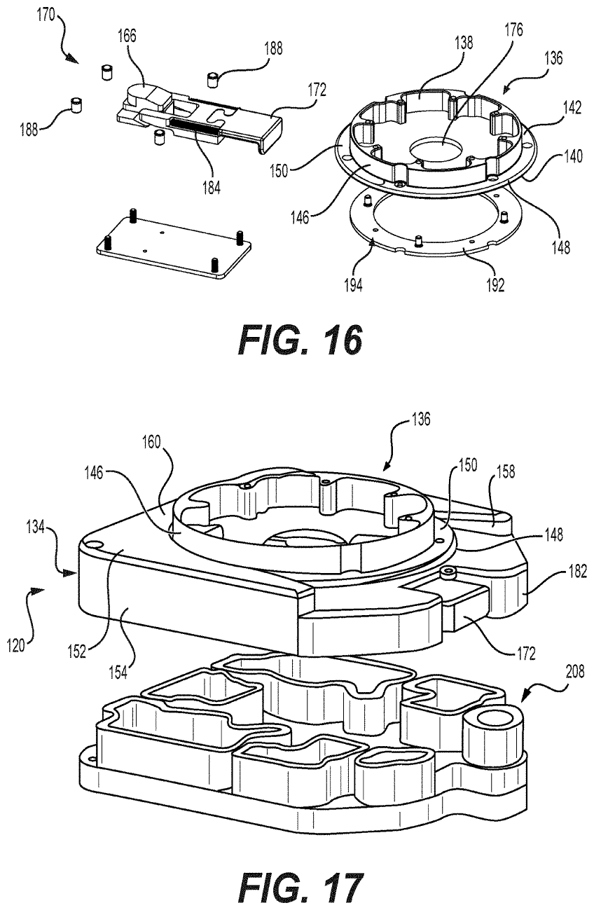

FIG. 16 is an exploded view of the release member of FIG. 9 and a lock mechanism, according to certain other embodiments of the present disclosure.

FIG. 17 is the base member of FIG. 9 and a damping member, according to certain other embodiments of the present disclosure.

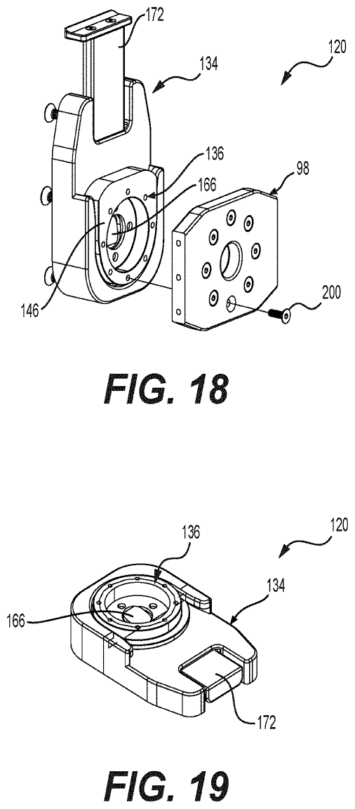

FIG. 18 is a coupling device comprising a base member, a release member, and a top plate, according to certain other embodiments of the present disclosure.

FIG. 19 is the coupling device of FIG. 18, with the top plate removed for clarity, and including a circular member, according to certain embodiments of the present disclosure.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENT(S)

Reference will now be made in detail to various non-limiting embodiments of a bracket for supporting portable equipment. It should be understood that other non-limiting embodiments, modifications and equivalents will be evident to one of ordinary skill in the art in view of the non-limiting embodiments disclosed herein and that these variants should be within scope of the appended claims. Furthermore, it will be recognized by one of ordinary skill in the art that certain structural and operational details of the non-limiting embodiments discussed hereafter may be modified or omitted (i.e. non-essential) altogether. In other instances, well known methods, procedures, and components have not been described in detail.

Referring initially to FIGS. 1-4, according to non-limiting embodiments of the present technology, there is provided a bracket 10 for supporting portable equipment 12. Although illustrated and described herein as relating to medical portable equipment, the portable equipment may also be non-medically related.

The bracket 10 comprises a body 14 which is plate-like. The body 14 has an upper surface 16 and a lower surface 18. A portion of the upper surface 16 is arranged to contact the portable equipment 12 for supporting the portable equipment.

For ease of description, although the body 14 has a one-piece construction, it can be described as comprising three portions: a central portion 20, a first wing portion 22 extending from one side of the central portion 20, and a second wing portion 24 extending from another side of the central portion 20. The sides from which the first wing portion 22 and the second portion 24 extend are oppositely facing. The body 14 is symmetrical in that the first wing portion 22 is a mirror image of the second wing portion 24. However, in certain embodiments, the body 14 may be asymmetric (not shown).

Legs 26 extend from the lower surface 18 of the body 14. In the illustrated embodiment, four legs 26a, 26b, 26c, 26d are provided: a first leg 26a and a second leg 26b extending downwardly from the first wing portion 22, and a second leg 26c and a third leg 26d extending downwardly from the second wing portion 24. The legs are integrally formed with the body 14. In other words, the legs 26a, 26b, 26c, 26d and the body are a single piece. In other embodiments, the legs 26a, 26b, 26c, 26d may be separate and attached thereto. In yet other embodiments, there may be provided more or less than the four legs 26 illustrated herein. In use and in a resting position, when the legs 26 of the bracket 10 rest on a surface, the bracket can space the portable equipment from the surface.

The bracket 10 further comprises a handle 27 integral with the body. In other words, the body 14 and the handle 27 are a single piece. The handle 27 is formed in the central portion 20 of the body 14. In other embodiments, the handle 27 may be separate and attached thereto. In yet other embodiments, the handle 27 may be omitted.

Each of the first wing portion 22, the second wing portion 24, and the central portion 20 has a planar surface 28, 30, 32 which together define the upper surface 16 of the bracket 10. The planar surface 28 of the first wing portion 22 and the planar surface 32 of the central portion 20 is off-set by a first angle 34. The planar surface 30 of the second wing portion 24 and the planar surface 32 of the central portion 20 is off-set by a second angle 36. As best seen in FIG. 3B, the second angle 36 is 5°. Similarly, the first angle 34 is also 5°. This renders the body 14 a concave profile when viewed from an end (FIGS. 3A, 3B) or in cross-section. The planar surface 32 of the central portion 20 is substantially horizontal when the bracket 10 is supported by the legs 26 on a horizontal surface 42 (FIG. 3A). The planar surface 28 of the first wing portion 22 slopes downwardly towards a first side edge 44 of the first wing portion 22. The planar surface 30 of the second wing portion 24 slopes downwardly towards a second side edge 46 of the second wing portion 24. The legs 26a, 26b are positioned at the first side edge 44, and the legs 26c, 26d are positioned at the second side edge 46. The planar surface 32 of the central portion 20 is spaced further from the horizontal surface 42 than the first side edge 44 of the first wing portion 22 and the second side edge 46 of the second wing portion 24. This can help to space any elements supported by the central portion 20 of the bracket 10 from the horizontal surface 42 and from potential damage that could be caused by impact with the horizontal surface 42. It will be appreciated that the horizontal surface 42 may not be horizontal and that it can have any orientation. The first and second side edges 44, 46 may be substantially parallel to one another.

In alternative embodiments (not shown), the first angle 34 and the second angle 36 may be different to one another. In further alternative embodiments (not shown), the first angle 34 and the second angle 36 may be the same or different to one another and may range from about 2° to about 15°, or from about 3° to about 10° degrees, or from about 3° to about 7°.

Each of the first wing portion 22 and the second wing portion 24 are substantially trapezoidal in shape. A width 56 of the central portion 20 is more than a width 58 of each of the first wing portion 22 and the second wing portion 24. In the embodiment that is illustrated in FIGS. 1-4, the width 56 of the central portion 20 is about twice the width 58 of the first wing portion 22 and about twice the width 60 of the second wing portion 24. For example, the width 56 of the central portion 20 is about 6.8 inches, and the width 58, 60 of each of the first wing portion and the second wing portion is about 3.2 inches, respectively.

The central portion 20, at the upper surface 16 of the body 14, comprises a recessed portion 62 for receiving a plate 64 for connecting the portable equipment 12 to the bracket 10. The plate 64 is best seen in FIG. 6. The central portion 20 has a central opening 66 formed therein and within the recessed portion 62. The central opening 66 is circular. Positioned around a periphery of the central opening 66 is a plurality of peripheral openings 68 for attaching an element, such as a release member 136 of a coupling device 120 thereto. The release member 136 and the coupling device 120 will be described later with reference to FIGS. 5 to 19. The central opening 66 is therefore sized according to a size of the release member 136. The central opening 66 serves to minimize a weight of the bracket 10.

Unlike the central portion 20, the first wing portion 22 and the second wing portion 24 are each a single piece with no openings. In other words, the planar surface 28 of the first wing portion 22 is uninterrupted, and the planar surface 30 of the second wing portion 24 is uninterrupted.

A total surface area of the upper surface 16 of the body 14, comprising a sum of the planar surface 28 of the first wing portion 22, the planar surface 30 of the second wing portion 24 and the planar surface 32 of the central portion 20, is more than about 35 in² and less than about 100 in², and in certain embodiments about 40-80 in², about 50-80 in², or about 70 in².

The bracket 10 including the body 14 (first wing portion 22, second wing portion 24, and central portion 20), the legs 26 and the handle 27 are a single piece. The bracket 10 is made of a material having a higher impact toughness than aluminium or an aluminium alloy. The bracket 10 is made of a material which can withstand a static load of 200 lb or more. In certain embodiments, the bracket is made of acrylonitrile butadiene styrene (ABS). In other embodiments, the bracket 10 can be made of any other polymer such as a thermoplastic, an elastomer, or a thermoset polymer.

The bracket 10 can be made by any suitable method, such as injection moulding, casting, additive manufacturing, or the like.

Turning now to the coupling device 120, best shown in FIGS. 9-19, which is configured to be attached to the portable equipment 12 via the bracket 10, and which is itself can detachably attach to support surfaces or transportation devices, etc. The coupling device 120 comprises a base member 134 connectable to a portion of the frame 16, and a release member 136 connectable to the equipment 12. The base member 134 and the release member 136 are releasably connectable.

The release member 136 has a body 138 which is plate-like and has a first side 140 and a second side 142. The first side 140 of the release member body 136 defines a planar contact face 144 for contacting the base member 134. The second side 142 of the release member 136 has a collar 146 extending therefrom, the collar 146 positioned inwardly of a perimeter 148 of the release member 136 to define a flange portion 150 of the release member 136.

The base member 134 has a front side 152 and a back side 154. The front side 152 has a planar contact portion 156 for contacting the contact face 144 of the release member 136. A shoulder 158 extends around a portion of a periphery 160 of the planar contact portion 156 to define a pocket 162 for receiving at least a portion of the release member 136. The shoulder 158 is engageable with a portion of the flange 150 of the release member 36 when the release member 136 is positioned on the base member 134.

The base member front side 152 has an open access end 164 through which the release member 136 can be slidingly inserted and removed from the pocket 162. As can be seen, the base member 134 is four-sided, with the shoulder 158 extending around three of the four sides and the fourth side being the open access end 164. In other embodiments, the base member 134 may have different numbers of sides.

A stop member 166 is positioned in a recess 168 within the planar contact portion 156 of the base member 134 and is moveable relative to the planar contact portion 156. The stop member 166 is moveable to extend out of the recess 168 and to be housed fully in the recess 168 by a coupling lock mechanism 170 and an actuator 172. The stop member 166 is actuatable between a lock position in which at least a portion of the stop member 166 extends from the recess 168 and a release position in which the stop member 166 is retracted into the recess 168 and does not extend from the recess 168. In the lock position, when the base member 134 and the release member 136 are coupled together, the stop member 166 can abut an edge 174 of an opening 176 defined in the release member contact face 144 to delimit movement of the release member 36 towards the open access end 64 (FIGS. 9-10). In the release position, the release member 136 can be decoupled from the base member 134 (FIG. 11).

The actuator 172 is positioned at the open access end 164. The actuator 172 is a push button 178 housed within a groove 180 formed at the open access end 164. The actuator 172 can be moved between a neutral position and a deployed position. When the actuator 172 is in the neutral position (FIG. 10), the stop member 166 is resiliently biased towards the lock position. As best seen in FIG. 11, when the actuator 172 is in the deployed position (pushed inwardly), the coupling lock mechanism 170 is arranged to move the stop member 166 to retract into the recess 168 in the release position. This can allow the release member 136 to be slid relative to the base member 134 and removed from the base member 134. In certain embodiments, the actuator 172 extends beyond a perimeter 182 of the base member 134 (FIG. 18) when in the neutral position. In other embodiments, the actuator 172 does not extend beyond the perimeter 182 of the base member 134 (FIGS. 16-18).

The coupling lock mechanism 170, best seen in FIGS. 15 and 16, comprises an actuator spring 184 resiliently biasing the actuator 172 outwardly to the neutral position, and a stop member spring 186 resiliently biasing the stop member 166 to the lock position. The actuator spring 184 and the stop member spring 186 extend in directions which are substantially transverse to one another.

The base member 134 comprises a plurality of spring loaded ball bearings 188 partially extending from recesses 190 formed in the planar contact portion 156 of the front side 152 of the base member 134 and engageable with corresponding recesses 192 defined in the planar contact face 144 of the release member 136. The spring loaded ball bearings 188 and the recesses 192 can guide the movement of the release member 136 relative to the base member 134.

In certain embodiments, the planar contact face 144 of the release member 136 comprises an anti-friction layer for reducing or minimizing friction between the contact faces 144, 156 of the release member 136 and the base member 134. As illustrated in FIGS. 14-16, the anti-friction layer comprises a disc 194 attached to the release member 136 and with an outer face 196 which is the planar contact face 144 and having anti-friction properties. In this embodiment, the recesses 192 for receiving the spring loaded ball bearings 188 are formed in the disc 194. In other embodiments, the anti-friction layer comprises a coating. The anti-friction layer may comprise any material that reduces friction between the base member 134 and the release member 136.

The coupling device 120 further comprises a top plate 198 attachable to the collar 146 of the release member 136 and attachable to the equipment 12. As best seen in FIG. 18, the top plate 198 is attached to the collar 146 by fasteners 200, such as screws. The top plate 198 has an opening formed therein.

In certain embodiments (for example as illustrated in FIGS. 9-17), when the base member 134 and the release member 136 are coupled together and in the lock position, the release member 136 is rotatable within the pocket 162 whilst maintaining the coupling. In this respect, the perimeter 148 of the plate-like body 138 of the release member 136 is circular in shape, the stop member 166 of the base member 134 is positioned substantially centrally of the planar contact portion 156, and the opening 176 of the release member 136 is positioned substantially centrally of the plate-like body 138, such that the release member 136 can be rotated within the pocket 162 when the stop member 166 is in the lock position. The stop member 166 can be considered to function also as a pivot point in these embodiments.

In certain other embodiments (for example as illustrated in FIGS. 18 and 19), when the base member 134 and the release member 136 are coupled together and in the lock position, the release member 136 is not rotatable within the pocket 162. In this respect, the perimeter 148 of the plate-like body 138 of the release member 136 has an eccentric shape such that the release member 136 is not rotatable in the pocket 162 of the base member 134. The perimeter 148 of the release member 136 may have a shape which is a multi-faceted geometric form. This embodiment of the coupling device 120 may be used when rotation of the equipment 12 is not required. In certain embodiments, the release member 136 further comprises a circular member 206 which is rotatable within the pocket 162 (FIG. 19).

In certain embodiments, the coupling device 120 is further provided with a damping member 208 (FIG. 17) attachable to the back side 154 of the base member 134 and arranged to be positioned between the base member 134 and the surface in use. The damping member 208 is arranged to absorb vibrations and shocks, and/or reduce energy transmission. In certain embodiments, the damping member 208 is made of any suitable material such as elastomeric materials.

Returning back to FIG. 7, the base member 134 can be mounted to a frame such as an arm 70. The arm 70 can itself be mounted to a transportation device such as a stretcher 72.

Certain embodiments of coupling devices and systems which could be used with the present bracket 10, are described in PCT/CA2020/051392 filed Oct. 16, 2020, PCT/CA2020/051329 filed Oct. 2, 2020, and PCT/CA2021/050253 filed Feb. 26, 2021, the contents of which are herein incorporated by reference in their entirety.

Variations and modifications will occur to those of skill in the art after reviewing this disclosure. The disclosed features may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented. Examples of changes, substitutions, and alterations are ascertainable by one skilled in the art and could be made without departing from the scope of the information disclosed herein.

It should be expressly understood that various technical effects mentioned throughout the description above need not be enjoyed in each and every embodiment of the present technology. As such, it is anticipated that in some implementations of the present technology, only some of the above-described technical effects may be enjoyed. While in other implementations of the present technology, none of the above enumerated technical effects may be present, while other technical effects not specifically enumerated above may be enjoyed. It should be expressly understood that the above enumerated technical effects are provided for illustration purposes only, to enable those skilled in the art to better appreciate embodiments of the present technology and by no means are provided to limit the scope of the present technology or of the claims appended herein below.

It is noted that the foregoing has outlined some of the more pertinent non-limiting embodiments. It will be clear to those skilled in the art that modifications to the disclosed non-embodiment(s) can be effected without departing from the spirit and scope thereof. As such, the described non-limiting embodiment(s) ought to be considered to be merely illustrative of some of the more prominent features and applications. Other beneficial results can be realized by applying the non-limiting embodiments in a different manner or modifying them in ways known to those familiar with the art. This includes the mixing and matching of features, elements and/or functions between various non-limiting embodiment(s) is expressly contemplated herein so that one of ordinary skill in the art would appreciate from this disclosure that features, elements and/or functions of one embodiment may be incorporated into another embodiment as skill in the art would appreciate from this disclosure that features, elements and/or functions of one embodiment may be incorporated into another embodiment as appropriate, unless described otherwise, above. Although the description is made for particular arrangements and methods, the intent and concept thereof may be suitable and applicable to other arrangements and applications.

1. A bracket for supporting portable equipment, the bracket comprising:
a body which is plate-like and having an upper surface for supporting the portable equipment, the body comprising:
a central portion,
a first wing portion extending from a first side of the central portion, and
a second wing portion extending from a second side of the central portion;
at least one leg extending downwardly from a lower surface of the body to space the supported portable equipment from a surface in use;
wherein a planar surface of the first wing portion is off-set by a first angle with respect to a planar surface of the central portion, and a planar surface of the second wing portion is off-set by a second angle with respect to the planar surface of the central portion.

2. The bracket of claim 1, wherein the planar surface of the first wing portion, the planar surface of the second wing portion, and the planar surface of the central portion define the upper surface of the body, and wherein the first angle is about 3 degrees to about 10 degrees.

3. The bracket of claim 2, wherein the second angle is about 3 degrees to about 10 degrees.

4. (canceled)

5. The bracket of claim 1, wherein when the at least one leg is resting on a surface, the bracket is configured such that a distance of the central portion from the surface is greater than a distance of the first wing portion and the second wing portion, respectively, from the surface.

6. The bracket of claim 1, wherein the first wing portion, the central portion and the second wing portion present a substantially concave profile of the body in cross-section.

7. The bracket of claim 1, wherein a width of the central portion is more than a width of each of the first wing portion and the second wing portion.

8. The bracket of claim 1, wherein a width of the central portion is about twice a width of each of the first wing portion and the second wing portion.

9. The bracket of claim 1, wherein the body is made of a material having a higher impact toughness than aluminum.

10. The bracket of claim 1, wherein the body is made of a material which can withstand a static load of 200 lb.

11. (canceled)

12. The bracket of claim 1, further comprising a handle connected to the body at a central portion thereof.

13-14. (canceled)

15. The bracket of claim 1, wherein the bracket is one-piece and is formed by molding.

16. (canceled)

17. The bracket of claim 1, wherein each of the first wing portion and the second wing portion are substantially trapezoidal in shape comprising three exposed sides and a fourth side which is integrally formed with the central portion.

18. (canceled)

19. The bracket of claim 1, wherein the planar surfaces of each of the first wing portion and the second wing portion at the upper surface of the body are uninterrupted.

20. The bracket of claim 1, wherein the at least one leg comprises four legs, first and second legs of the four legs extending from the first wing portion and third and fourth legs of the four legs extending from the second wing portion.

21. The bracket of claim 1, wherein the planar surface of the central portion at the upper surface of the body comprises a recessed portion for receiving a plate for connecting the mobile equipment to the bracket.

22-25. (canceled)

26. The bracket of claim 1, wherein a total surface area of the upper surface of the body, comprising a sum of the upper planar surface of the first wing portion, the upper planar surface of the second wing portion and the upper planar surface of central portion, is more than about 35 in² and less than about 100 in².

27. The bracket of claim 1, further comprising a release member of a coupling device, the coupling device arranged to releasably attach the bracket to a support surface in use, the release member comprising a plate-like body with a first side, the first side defining a planar contact face, and a second side having a collar extending therefrom, the collar positioned inwardly of a perimeter of the release member to define a flange portion.

28. The bracket of claim 27, further comprising a base member of the coupling device, the base member and the release member being releasably connectable together in a coupled position, the base member being connectable to the support surface and having:
a front face including a planar contact portion for contacting the contact face of the release member;
a shoulder extending around a portion of a periphery of the planar portion to define a pocket for receiving the release member, the shoulder engageable with a portion of the flange of the release member when the release member is positioned on the base member;
an open access end through which the release member can be slidingly inserted and removed from the pocket;
a stop member positioned in a recess within the planar contact portion and moveable by a resilient lock mechanism and an actuator between a lock position in which at least a portion of the stop member extends from the recess and abuts an edge of an opening defined in the release member contact face in the coupled position, and a release position in which the stop member is retracted into the recess;
the actuator having a neutral position and a deployed position, wherein when the actuator is in the neutral position, the stop member is resiliently biased towards the lock position.

29-34. (canceled)

35. A bracket for supporting portable equipment, the bracket comprising:
a body which is plate-like and has an upper surface which is arranged to support the portable equipment, and a lower surface having at least one leg extending downwardly therefrom to space the supported portable equipment from a surface in use;
wherein the bracket is one-piece and made of a material that can withstand a static vertical load of more than 200 lb without fracture.

36. (canceled)
